(19) United States
(12) Patent Application Publication
(10) Pub. No.: US 2010/0172347 A1
(43) Pub. Date: Jul. 8, 2010

(54) VOICE COMMUNICATION BETWEEN USER EQUIPMENT AND NETWORK

(75) Inventor: Haris ZISIMOPOULOS, Middlesex (GB)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/652,208

(22) Filed: Jan. 5, 2010

(30) Foreign Application Priority Data
Jan. 6, 2009 (GB) 0900190.0

(51) Int. Cl. H04L 12/66

(52) U.S. Cl. 370/352

(57) ABSTRACT

User equipment (UE), for communicating wirelessly with communication networks, is disclosed, the UE being adapted so as to be capable of voice communication with communication networks via a plurality of mechanisms, the plurality of mechanisms comprising at least one packet-switched (PS) mechanism and at least one circuit-switched (CS) mechanism. The UE is further adapted, when at a location at which the UE is able to communicate wirelessly with a particular communication network, to communicate with the network to determine which voice communication mechanisms the network is adapted to use. The UE is further adapted to select a voice communication mechanism according to a result of the determination and according to said plurality of mechanisms the UE is adapted to use, and to provide voice communication with the network via the selected mechanism. A corresponding method is disclosed.

### PRIORITY

This application claims the benefit under 35 U.S.C. §119(a) of a UK Patent Application filed in the British Patent Office on Jan. 6, 2009 and assigned Serial No. 0900190.0, the entire disclosure of which is hereby incorporated by reference.

### BACKGROUND OF THE INVENTION

1. Field of the Invention

This invention generally relates to methods of providing voice communication between user equipment (UE) and a communication network, and to UE adapted for use in such methods. Certain aspects of the invention are also concerned with communication systems in which the methods are implemented, computer programs for implementing the methods, and to storage media storing such programs.

2. Description of the Related Art

A number of abbreviations will be used throughout this specification, and are identified in the following table.

| | |
|---|---|
| ADS | Access Domain Selection |
| AS | Application Server |
| CN | Core Network |
| CS | Circuit Switch |
| CSoEPS | CS over EPS |
| EPC | Enhanced Packet Core |
| EPS | Enhanced Packet System (For information: eNB + EPC = |
| | EPS) |
| HPLMN | Home PLMN |
| ICS | IMS Centralised Services |
| IMS | IP MultiMedia Subsystem |
| IP | Internet Protocol |
| IP-CAN | IP-Connectivity Access Network |
| LTE | Long Term Evolution (relate most to the Radio Access |
| | Network) |
| MSC-S | MSC Server |
| MGCF | Media Gateway Control Function |
| MME | Mobility Management Entity |
| MO | Mobile Originating |
| MT | Mobile Terminating |
| PLMN | Public Land Mobile Network |
| PS | Packet Switched |
| QoS | Quality of Service |
| QCI | QoS Class Identifier |
| SAE | System Architecture Evolution (relate most to the EPC) |
| SCC | Service Centralisation and Continuity |
| SRVCC | Single Radio VCC |
| T-ADS | Terminating ADS |
| UE | User Equipment |
| UMTS | Universal Mobile Telecommunications System |
| VCC | Voice Call Continuity |
| VoIP | Voice over IP |
| VoIMS | VoIP using IMS |
| VoIMSoLTE | VoIP using IMS over LTE |
| VPLMN | Visited PLMN |

The SAE/LTE system that is now currently being designed, specified and standardised by 3GPP is a PS (packet-switched) only system. This means there is no CS (circuit-switched) domain and the voice calls in that SAE/LTE system are “natively” through the PS domain only. Hence as the “default option” these voice calls will be VoIP calls and the underlying call control protocol will be SIP supported through IMS.

Nonetheless as part of rel. 8 of 3GPP SAE and due to demands for different deployment scenarios in next generation networks, different “alternative voice delivery mechanisms” have been defined and co-exist as part of the 3GPP standards. These include:
VoIP with CSoEPS: voice frames are delivered using PS transport for the delivery voice frames and CS signalling tunnelled to the CS infrastructure encapsulated in IP. This solution is defined in reference [5] (see references at end of description).
CS fallback: which involves steering the UE to CS access in an appropriate CS-capable legacy network (e.g. GSM,UMTS, CDMA2000 1xRTT) when a voice call is about to be made or received. This solution is defined in reference [3].

As mentioned above these “alternative voice delivery mechanisms” exist on top of the “default option” which is:
VoIP with IMS: VoIP delivered using PS access for the delivery of voice frames and IMS SIP for signalling.

Currently, which voice delivery mechanism is used for voice communication between UE and a network is determined by a static configuration of the UE (in other words, it is set or defined by operator policy). The UE will typically be configured to use a particular voice call mechanism for voice call communication with a network. This can lead to problems, particularly in roaming scenarios where the UE is moved (i.e. roams) from one network (e.g. a “home” network, or HPLMN) to another network (e.g. a “visited” network, VPLMN). For example, the VPLMN may not support the mechanism that the UE is configured to use in the HPLMN. Another way of looking at this problem is that different UEs may be configured to use different mechanisms for voice communication, as may different networks (which may be, or may comprise, access networks). This can lead to compatibility problems.

One possible solution is to adapt a particular communication network so that it can accommodate a variety of UE configurations, so as to be able to establish voice communications with a range of UEs roaming into its coverage area, those different UEs being adapted to use a range of different mechanisms. However, this is itself problematic, placing a burden on the network provider, and increasing complexity and cost.

Problems with the state of the art will now be discussed in more detail: Current voice delivery techniques developed as part of the rel. 8 work in 3GPP assume that the choice of the appropriate voice service delivery mechanism will be based on some static configuration in the UE.

The following example illustrates a problem with such current techniques, and illustrates limitations imposed in the roaming scenario:

An operator A has statically configured its UEs to use VoIMSoLTE and these UEs roam to VPLMN of operator B that does not primarily support VoIMSoLTE, rather another alternative voice delivery mechanism (e.g. CS fallback, CSoEPS). The UE of operator A needs to establish (UE-or NW-originated) a dedicated bearer in order to transport the SIP signalling to the home P-CSCF in addition to the default EPS bearer. After that, when it attempts to establish the voice call it will also require support for certain QoS for the voice to be transported. This requires support for certain QoS in the form of specific QCIs required for VoIP and, in the case of S8-PMIP, also support for PCC-roaming and PCC in the VPLMN. It will also require that the operator in the VPLMN will “open”, with appropriate filters, the dedicated bearer for IMS traffic, although this operator may not use IMS for its own subscribers. In addition to that if the IMS UEs from operator A are also SR-VCC capable in order for SR-VCC handover to be provided the MME in the VPLMN needs to support SR-VCC handover procedures.

All this requires: quite a lot of features and procedures to be mandated in roaming agreements and it may not be workable in practice; investment in IMS-related functionality (such as PCC and SR-VCC), when the primary driver of an operator that does not want to invest in IMS is to minimise this investment; and static configuration in the UEs with un-defined (at the moment) mechanisms—i.e. there is no OMA DM MO that you can use to determine the appropriate voice mechanism.

It is an aim of certain embodiments of the invention to solve, mitigate, or obviate, at least partly, at least one of the problems and/or disadvantages associated with the prior art.

### SUMMARY OF THE INVENTION

In accordance with a first aspect of the present invention there is provided user equipment (UE) for communicating wirelessly with communication networks,

the UE being adapted so as to be capable of voice communication with communication networks via a plurality of mechanisms, the plurality of mechanisms comprising at least one packet-switched (PS) mechanism and at least one circuit-switched (CS) mechanism,

the UE being further adapted, when at a location at which the UE is able to communicate wirelessly with a particular communication network, to communicate with the network to determine (i.e. make a determination of) which voice communication mechanisms the network is adapted to use,

the UE being further adapted to select a voice communication mechanism according to a result of the determination and according to said plurality of mechanisms the UE is adapted to use, and

the UE being further adapted to provide voice communication with the network via the selected mechanism.

Advantageously, the UE is thus able to adapt to, and take into account, the capabilities of the network and make a selection (decision) itself as to which voice communication mechanism to use in the current circumstances. This provides significant advantages over prior art techniques in which the network was adapted to accommodate a variety of UEs that might roam into its coverage area.

In certain embodiments the UE is further adapted so as to be IMS capable.

In certain embodiments the UE is further adapted so as to be IMS Centralised Services capable.

In certain embodiments the UE is further adapted so to use a specific feature tag in the IMS Centralised Services registration indicating the support for “alternative voice delivery mechanism” notifying the relevant selection application server (e.g. SCC AS) that “alternative voice delivery mechanism” is the selected mechanism in order to adapt the terminating domain selection.

In certain embodiments the plurality of mechanisms include VoIP with IMS.

In certain embodiments the plurality of mechanisms include CSoEPS.

In certain embodiments the plurality of mechanisms include CS fallback.

In certain embodiments the UE is adapted to communicate with the network to determine whether the network is adapted to use VoIP with IMS. In certain embodiments the UE is adapted to perform IMS registration if the network is adapted to use VoIP with IMS.

In certain embodiments the UE is adapted to perform IMS registration with IMS Centralised Services extensions if the network is adapted to use VoIP with IMS.

In certain embodiments the UE is adapted to determine whether operator policy in the network allows at least one alternative voice delivery mechanism, if the network is not adapted to use VoIP with IMS.

In certain embodiments the UE is further adapted to communicate with the network to determine whether operator policy in the network allows at least one alternative voice delivery mechanism, if the network is not adapted to use VoIP with IMS.

In certain embodiments the UE is further adapted to determine, if operator policy in the network allows at least one alternative voice delivery mechanism, whether the UE itself is adapted so as to be capable of voice communication with the communication network via at least one said alternative delivery mechanism.

In certain embodiments the UE is further adapted, if it determines that it is capable of voice communication with the network via at least one said alternative delivery mechanism, to select a said alternative delivery mechanism for communication with the network.

In certain embodiments the UE is adapted to communicate with the network to determine if the network is adapted to provide voice communication with the UE via at least one mechanism of the plurality of mechanisms.

In certain embodiments the UE is adapted, if it determines that the network is adapted to provide voice communication with the UE via at least one said mechanism, to select a said mechanism for communication with the network.

In certain embodiments the UE is adapted, if it determines that the network is not adapted to provide voice communication with the UE via at least one said PS mechanism, to determine whether the network is adapted to provide voice communication with the UE via at least one CS mechanism of the plurality of mechanisms.

In certain embodiments the UE is adapted to perform IMS registration with specific indicator if the network is adapted to use CS mechanism for the delivery of voice.

In certain embodiments the UE is adapted to communicate with the network to determine if the network is adapted to provide voice communication with the UE via at least one PS mechanism of the plurality of mechanisms.

In certain embodiments the UE is adapted, if it determines that the network is adapted to provide voice communication with the UE via at least one said PS mechanism, to select a said PS mechanism for communication with the network.

In certain embodiments the UE is adapted, if it determines that the network is not adapted to provide voice communication with the UE via at least one said PS mechanism, to determine whether the network is adapted to provide voice communication with the UE via at least one CS mechanism of the plurality of mechanisms.

In certain embodiments the UE is adapted, if it determines that the network is adapted to provide voice communication with the UE via at least one said CS mechanism, to select a said CS mechanism for communication with the network.

Another aspect of the invention provides a communication system comprising user equipment in accordance with any of the accompanying claims, and a communication network, the communication network being adapted so as to be capable of voice communication with the UE via at least one of said plurality of mechanisms.

Another aspect of the invention provides a method of providing wireless voice communication between user equipment (UE) and a communication network, the method comprising:

providing UE adapted so as to be capable of voice communication with communication networks via a plurality of mechanisms, the plurality of mechanisms comprising at least one packet-switched mechanism and at least one circuit-switched mechanism;

positioning the UE at a location at which the UE is able to communicate wirelessly with a particular communication network;

operating the UE to communicate with the network and determine (i.e. make a determination of) at least one voice communication mechanism the network is adapted to use; and

operating the UE to select a voice communication mechanism according to a result of the determination and according to said plurality of mechanisms the UE is adapted to use.

In certain embodiments the method further comprises: establishing voice communication between the UE and the network via the selected mechanism.

In certain embodiments the UE is further adapted so as to be IMS capable.

In certain embodiments the UE is further adapted so as to be IMS Centralised Services capable.

In certain embodiments the UE is operated to use a specific feature tag in the IMS Centralised Services registration indicating the support for “alternative voice delivery mechanism” notifying the relevant selection application server (e.g. SCC AS) that “alternative voice delivery mechanism” is the selected mechanism in order to adapt the terminating domain selection.

In certain embodiments the plurality of mechanisms include at least one of: VoIP with IMS; CSoEPS; and CS fallback.

In certain embodiments, operating the UE to communicate with the network and determine at least one voice communication mechanism the network is adapted to use comprises operating the UE to communicate with the network and determine at least one voice communication mechanism an access network of the communication network is adapted to use.

In certain embodiments the method further comprises operating the UE to communicate with the communication network and determine whether the communication network is adapted to use VoIP with IMS.

In certain embodiments the method further comprises operating the UE to perform IMS registration if the communication network is adapted to use VoIP with IMS.

In certain embodiments the method further comprises operating the UE to perform IMS registration with IMS Centralised Services extensions if the network is adapted to use VoIP with IMS.

In certain embodiments the method further comprises operating the UE to communicate with the communication network to determine whether operator policy in the communication network allows at least one alternative voice delivery mechanism, if the communication network is not adapted to use VoIP with IMS.

In certain embodiments the method further comprises operating the UE to determine, if operator policy allows at least one alternative voice delivery mechanism, whether the UE itself is adapted so as to be capable of voice communication with the communication network via at least one said alternative delivery mechanism.

In certain embodiments the method further comprises operating the UE, if it determines that it is capable of voice communication with the network via at least one said alternative delivery mechanism, to select a said alternative delivery mechanism for communication with the network.

In certain embodiments the method further comprises operating the UE to communicate with the communication network to determine if the communication network is adapted to provide voice communication with the UE via at least one mechanism of the plurality of mechanisms.

In certain embodiments the method further comprises operating the UE, if it determines that the communication network is adapted to provide voice communication with the UE via at least one said mechanism, to select a said mechanism for communication with the communication network.

In certain embodiments the method further comprises operating the UE, if it determines that the communication network is not adapted to provide voice communication with the UE via at least one said PS mechanism, to determine whether the communication network is adapted to provide voice communication with the UE via at least one CS mechanism of the plurality of mechanisms.

In certain embodiments the method further comprises operating the UE, if it determines that the communication network is adapted to provide voice communication with the UE via at least one said CS mechanism, to select a said CS mechanism for communication with the communication network.

Another aspect of the invention provides a computer program comprising instructions arranged, when executed, to implement a method as claimed in any of the claims of this specification.

Another aspect of the invention provides machine-readable storage storing a program as claimed in any claim of this specification.

Another aspect of the invention provides A voice call service communication system in a communication system, comprising: a User Equipment (UE) configured to communicate with a communication network to determine if the communication network is capable of servicing a voice call in a Packet-Switched (PS) domain or not, and to service the voice call with the communication network in the PS domain if the communication network is capable of servicing the voice call in the PS domain.

Another aspect of the invention provides A voice call service communication system in a communication system, comprising: a communication network to communicate with a User Equipment (UE) and to service a voice call in a Packet-Switched (PS) domain or a Circuit-Switched (CS) domain.

### BRIEF DESCRIPTION OF THE DRAWINGS

Embodiments of the invention are further described hereinafter with reference to the accompanying drawings, in which:

FIG. 1 is a flow chart illustrating steps in a method embodying the invention:

FIG. 2 illustrates a step in a method embodying the invention;

FIG. 3 illustrates steps step in a method embodying the invention;

FIG. 4 illustrates steps step in a method embodying the invention;

FIG. 5 illustrates steps performed in a method embodying the invention;

FIG. 6 illustrates steps performed in a method embodying the invention;

FIG. 7 illustrates steps performed in a method embodying the invention;

FIG. 8 illustrates steps performed in a method embodying the invention; and

FIG. 9 illustrates steps performed in a method embodying the invention.

### DETAILED DESCRIPTION OF THE PREFERRED EMBODIMENT

It will be appreciated that certain embodiments of the invention provide a dynamic selection procedure for voice delivery mechanism. Certain embodiments are concerned with the selection of appropriate voice delivery mechanism in user equipment (such as mobile phones, personal digital assistants etc.) in so-called next generation networks, such LTE or WiMAX.

As mentioned above, currently the voice delivery mechanism to be used by the UE relies on static configuration (operator policy). This is not adequate particularly in roaming scenarios.

In certain embodiments of the invention the UE is adapted to select the most appropriate voice delivery mechanism that is supported in the VPLMN rather than the HPLMN and various mechanisms can co-exist as part of the UE's capabilities.

Thus, embodiments of the invention are able to provide solutions to the roaming problem with a selection method (in contrast to the prior art techniques utilising UEs statically configured, according to local operator policy). Certain methods embodying the invention are implemented using IMS-capable UEs that are also capable of more than one other alternative voice delivery mechanism.

It will be appreciated that certain embodiments of the invention alleviate the problem of using a sub-optimal voice delivery mechanism when the IMS UE operates in a VPLMN where the voice delivery mechanism that is primarily supported in the HPLMN is not supported. They also avoids the requirement for an operator to support a minimum set of features in the network only in order to support roaming UEs. As a result, embodiments are able to minimize (or at least reduce) the cost incurred in the operator of the VPLMN in order to support these features.

In addition to the above, embodiments provide clear benefits to the handset manufacturer by allowing the co-existence of multiple voice delivery solution in a single terminal implementation, and avoiding the fragmentation imposed by providing different voice solutions for different deployments and markets (and avoiding the customization cost that is incurred as a result of that).

The combination of IMS Centralised Services and CS delivery mechanisms such as CS fallback and CSoEPS are investigated in the description below document, and embodiments of the invention are described which provide a solution to make the co-existence possible. Certain embodiments employ a novel decision method that the UE follows (implements) in order to select the most appropriate voice delivery mechanism in the VPLMN in which it operates.

Certain embodiments use a novel specific feature tag in the ICS registration indicating the support for “alternative voice delivery mechanism” notifying the relevant domain selection application server of the IMS domain (e.g. SCC AS) that “alternative voice delivery mechanism” is the selected mechanism in order to adapt the relevant domain selection (T-ADS). This is only applicable to the case where the ICS-capable UE does not support UE-assisted T-ADS or it is the operator's policy not to use UE-assisted T-ADS.

In certain embodiments (but not all), Pre-requisites/Basic assumptions are as follows:
The UE and the network are EPS compliant
The UE is IMS capable.
The network in the VPLMN supports only alternative voice delivery mechanisms (i.e. CS fallback or CSoEPS) for the “home” UEs and is not using IMS for home services and any form of IMS roaming.
The UE becomes aware of the fact that VoIP is not possible in the VPLMN (e.g. from the radio capabilities in the particular cell that is attached to). This can be performed using the mechanism described in reference [6]
The UE is primarily using VoIMS when in the HPLMN—i.e. VoIMS is the primary choice for voice delivery in the HPLMN
Support for ICS is not necessary in the UE and the network (i.e. MSC-S)

Note: Throughout this document we use the term “alternative voice delivery mechanism” in order to refer to the already specified solution of CS fallback [3] and CSoEPS [5]. Nevertheless, the scope of the invention is not limited to such mechanisms, and indeed can be extended to encompass any voice delivery mechanisms, e.g. any mechanisms that can co-exist with VoIMS in next generation handsets.

In certain methods embodying the invention, the UE is adapted to implement a selection method in order to select the most appropriate voice delivery mechanism using as inputs its own capabilities, the capabilities of the access network in the VPLMN and the (local) operator pre-configured policy.

Certain embodiments use a specific feature tag in the ICS registration indicating the support for “alternative voice delivery mechanism” notifying the relevant domain selection application server of the IMS domain (e.g. SCC AS) that “alternative voice delivery mechanism” is the selected mechanism in order to adapt the domain selection (e.g. T-ADS). This use of the specific feature tag is only applicable to the case where the ICS-capable UE does not support UE-assisted domain selection (T-ADS) or it is the operator's policy not to use UE-assisted domain selection (T-ADS).

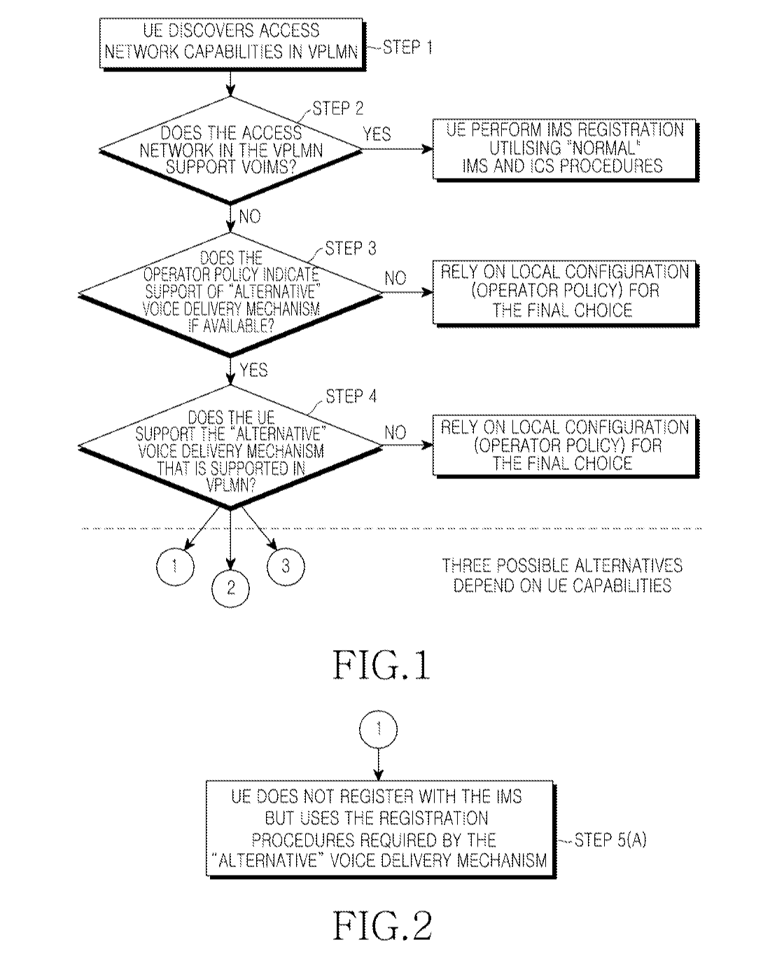

Referring now to FIG. 1, a method embodying the invention comprises the following steps:

Step 1: The UE discovers the access network capabilities (i.e. communicates with the network to make a determination of which mechanisms it can use/support) in terms of voice delivery mechanisms in the VPLMN. This can be done using the mechanisms described in [6].

Step 2: If the access network capabilities in VPLMN indicate support for VoIMS then the UE performs IMS and ICS registration (if required) as described in [1] and [2]. If the access network capabilities in VPLMN do not indicate support for VoIMS rather they indicate support of an “alternative voice delivery mechanism” then the UE proceeds to step 3. If there is no support for any voice delivery mechanism the method terminates here and is indicated that no voice can supported in VPLMN.

Step 3: If the operator policy does not indicate the use of “alternative voice delivery mechanism” in the VPLMN then the UE proceeds with the indicated operator defined policy. If the operator policy does allow the use of “alternative voice delivery mechanism” in the VPLMN then the proceeds with step 4.

Step 4: If the UE does not support the “alternative voice delivery mechanism” that is supported in the VPLMN then static operator policy is performed (e.g. the UE attempts to use VoIMS even though the VPLMN does not support all the relevant features or it is indicated that voice is not supported in the VPLMN). If the UE does support the “alternative voice delivery mechanism” that is supported by the network in the VPLMN then three alternatives apply depending on the capabilities of the UE.

Alternative 1 (as illustrated in FIG. 2): If the UE is not required to support any other services apart from voice using IMS, or the UE does not have ICS capabilities, then the following steps apply:

Step 5(a): The UE does not perform IMS registration at all, or if it was registered to IMS before over a different access network, it de-registers, and initiates registration to the “alternative voice delivery mechanism” using the relevant procedures defined for that.

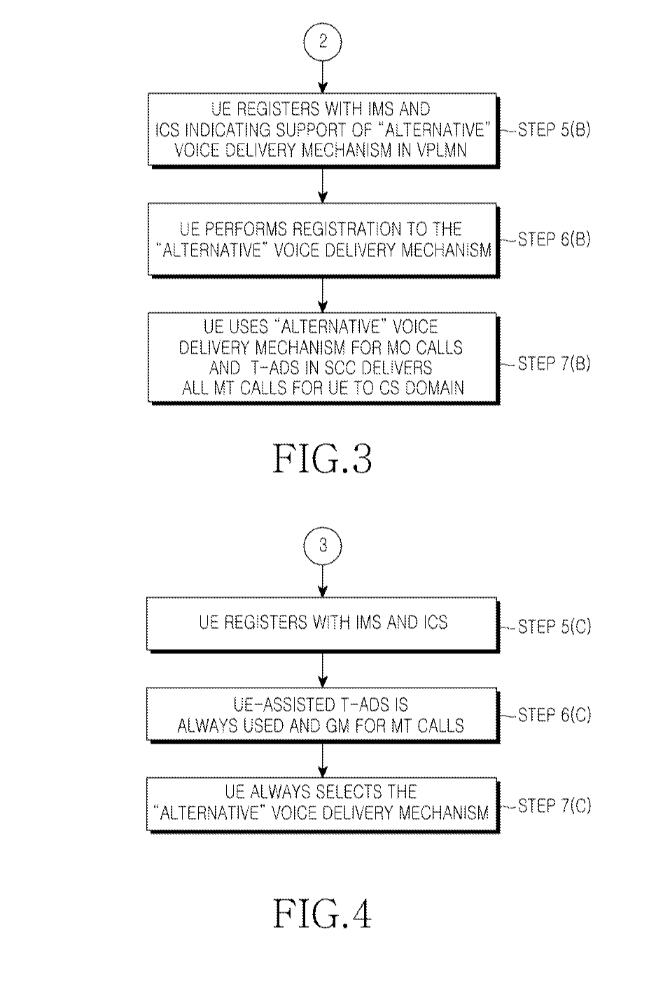

Alternative 2 (as illustrated in FIG. 3): If the UE is supporting ICS but is not supporting UE-assisted T-ADS or the operator policy is not to support UE-assisted T-ADS then the following steps apply:

Step 5(b): The UE performs IMS and ICS registration. In the ICS registration it indicates to the SCC AS the “alternative voice delivery mechanism” that is supported in the VPLMN. This can be indicated through the inclusion of a new “feature tag” that will need to be defined for that purpose.

Step 6(b): The UE performs registration to the “alternative voice delivery mechanism” using the relevant procedures defined there.

Step 7(b): The SCC AS uses the T-ADS to always deliver the voice service signalling to the CS domain. As a result the MT are always breaking out of the IMS to the MGCF and reach the UE through the MSC-S in the VPLMN. For the MO calls the UE uses the relevant MO procedures defined for the relevant “alternative voice delivery mechanism”.

Alternative 3 (as illustrated in FIG. 4): If the UE is supporting ICS and is supporting UE-assisted T-ADS and the operator policy is to support UE-assisted T-ADS then the following steps apply:

Step 5(c): The UE performs IMS and ICS registration as normal (i.e. no need for any specific feature tag).

Step 6(c): UE-assisted T-ADS is always used, hence the Gm interface as defined in [1] and following the appropriate procedures defined in [2].

Step 7(c): The UE through the UE-assisted T-ADS always selects the “alternative voice delivery mechanism” for MO and MT calls.

### Further Embodiments

The following section describes embodiments of this invention with the usage of CS fallback as defined in [3].

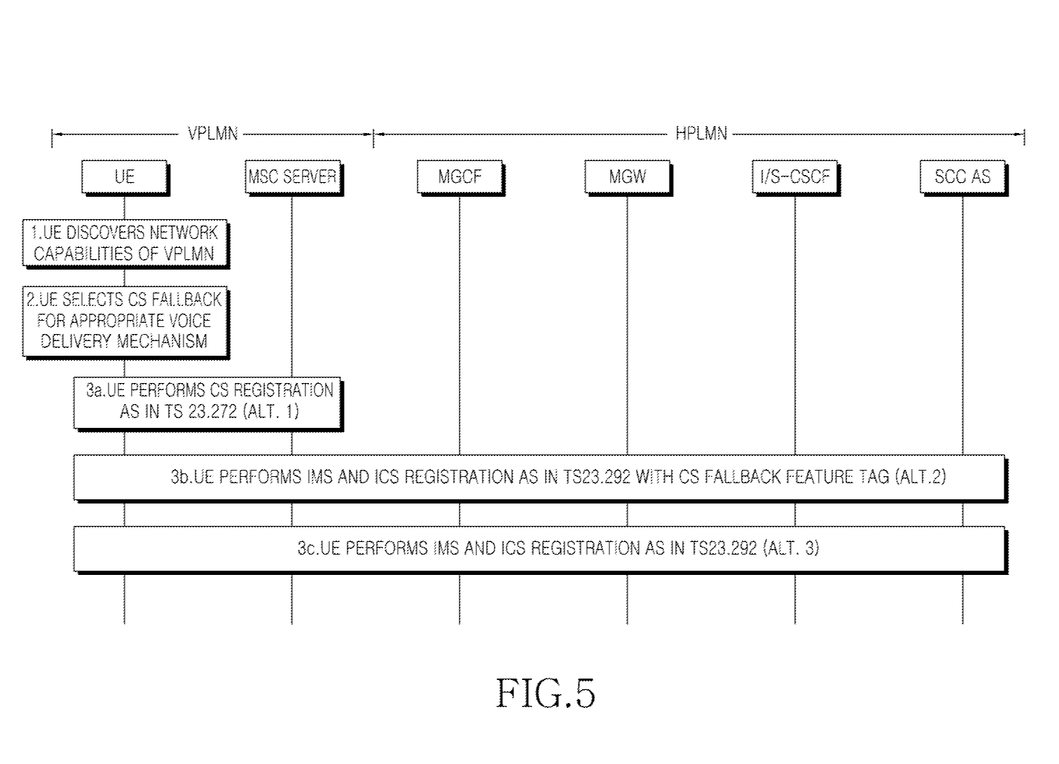

Alternative 1 (as illustrated in FIG. 5): The ICS UE does not register with IMS when it moves in CS fallback IP-CAN, the ICS procedures for non ICS UEs are followed

In this alternative the ICS UE, when it moves to an IP-CAN that supports CS fallback but does not support VoIP, does not register with IMS (or if it is registered it de-registers) and follows procedures similar to the ones described in ICS [2] for non-ICS UEs. Effectively in this alternative the voice calls for this UE can still be centralised in the IMS in the HPLMN using the procedures for non-ICS UEs.

When the UE moves to an IP-CAN in the VPLMN that can supports VoIP or can use CS bearers by default (e.g. HSPA UTRAN) then it can re-register to the IMS indicating that audio can be supported and normal T-ADS procedures to be followed from there on.

To summarise the requirements derived from this alternative are:
The ICS UE does not register with IMS for voice services (if it is already registered it de-registers)
The MSC or MSC-S registers to the IMS and SCC AS on behalf of the UE using I2
The SCC AS uses T-ADS to terminate all voice sessions to CS media for this particular UE, using ICS procedures applicable to non-ICS UEs and legacy MSC or MSC-S
The ICS UE always uses CS bearers and CS fallback procedures to setup the voice calls as long as it is in an IP-CAN that supports CS fallback.

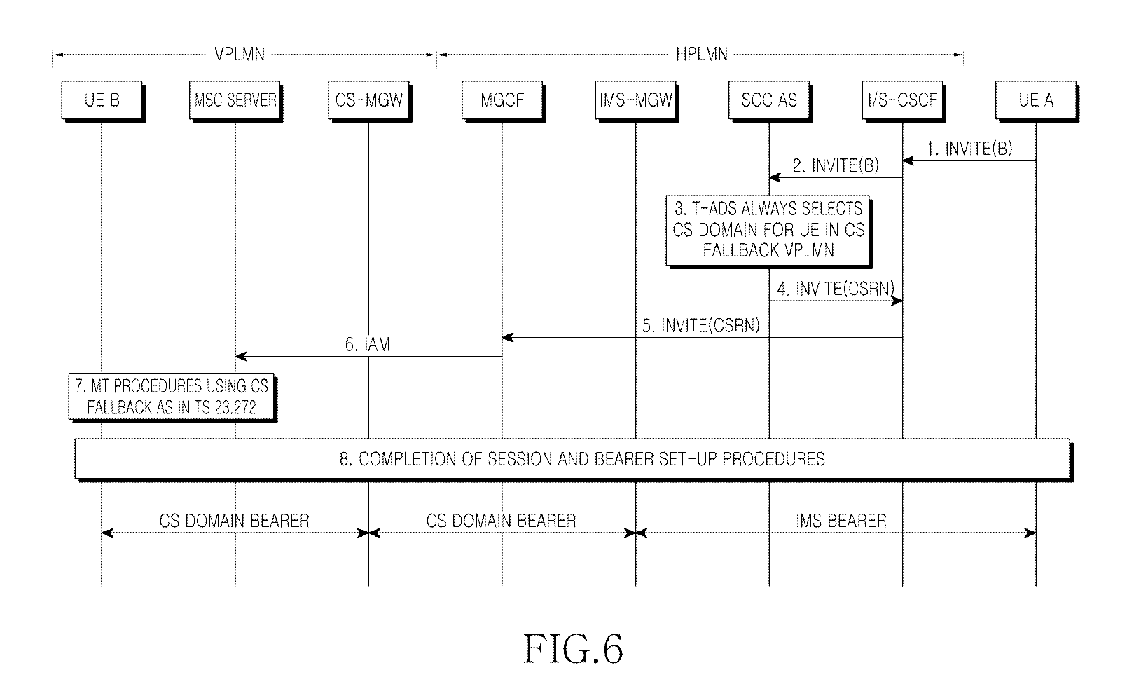

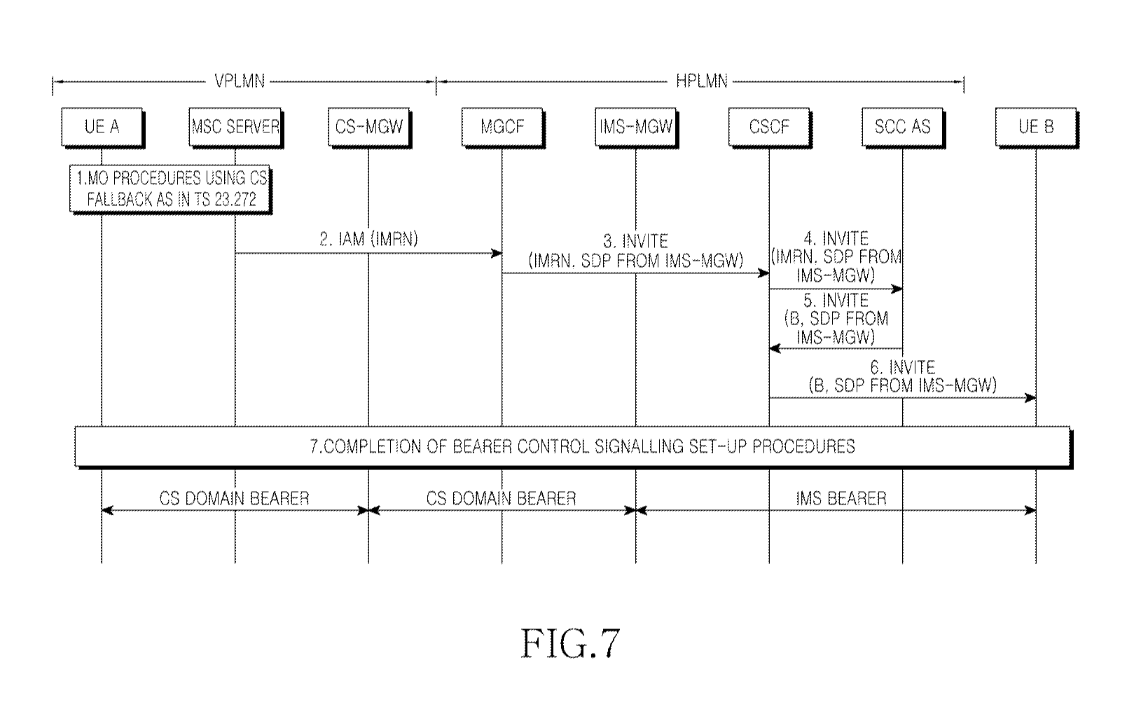

Alternative 2 (as illustrated in FIGS. 6 and 7): The ICS UE registers with IMS using Gm indicating CS fallback network capabilities, the network uses T-ADS to send all incoming voice calls to CS for the UE and the UE uses MO CS fallback procedures for outgoing calls

In this alternative the UE indicates upon IMS registration using Gm that the VPLMN IP-CAN that has attached to is CS fallback capable. This can be for example with the use of a particular feature tag used in the SIP REGISTER request or the indication that audio is not supported in its UA Caps. The SCC AS then uses this information as an input to the T-ADS and always terminates all the incoming voice calls to CS. The MSC then uses the normal CS fallback paging procedure in order to deliver the voice call over 2G/3G.

For the MO (mobile originating) procedures the UE uses the CS fallback MO procedures in order to perform the call, but the call is routed through the IMS as in the case of ICS UEs using CS for call establishment and a legacy MSC or MSC-S not enhanced for ICS. The MSC in this case using IN mechanisms fetches the UE's IMRN and routes the request to the UE's home network IMS.

When the ICS UE moves over to an IP-CAN that supports VoIP in the VPLMN or it can support CS by default (e.g. HSPA UTRAN) then it can re-register to the IMS indicating this time that audio is supported and/or that CS fallback is not the preferred option.

To summarise the requirements derived from this alternative are:
The ICS UE indicates to the IMS upon IMS registration that the VPLMN supports CS fallback and/or CS fallback is the preferred option to deliver voice
The SCC AS uses T-ADS to terminate all voice sessions to CS media for this particular UE, using ICS procedures applicable to non-ICS UEs and legacy MSC or MSC-S
The ICS UE always uses CS bearers and CS fallback procedures to setup the voice calls as long as it is in an IP-CAN that supports CS fallback.

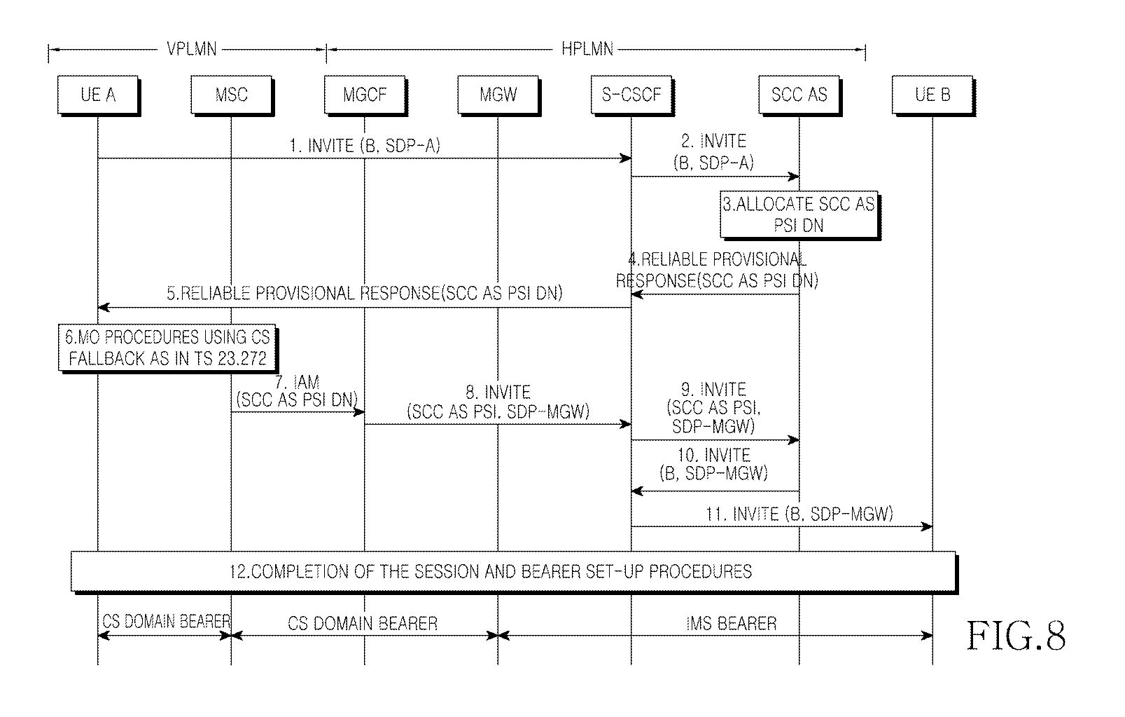

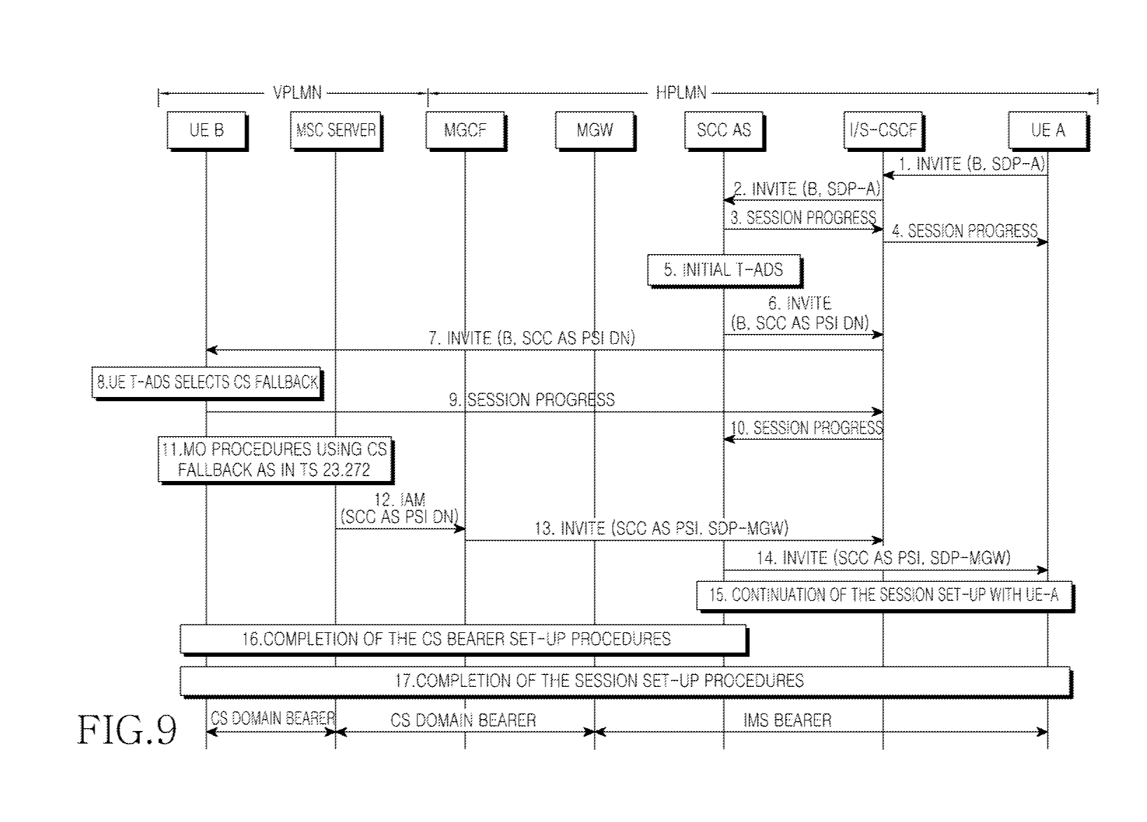

Alternative 3 (as illustrated in FIGS. 8 and 9): The ICS UE registers with IMS following normal IMS registration procedures using the Gm, UE-Assisted domain mechanisms are used for MT and MO calls for CS fallback.

In this alternative the UE uses Gm over the IP-CAN that supports CS fallback and not VoIP in order register with IMS following the normal registration procedures for an ICS UE.

For the MO calls the UE always selects the CS media and in respect the CS fallback MO procedures even though it uses the Gm as the signalling to perform the voice calls. An example of MO call for this alternative is shown in 8.

For MT calls the UE assisted T-ADS mechanisms are used and the UE when in an IP-CAN that supports CS fallback but not VoIP always selects CS media and sets up the voice call following MO procedures for CS fallback. The flow is indicated in 9.

When the UE moves to an IP-CAN in the VPLMN that can supports VoIP or can use CS bearers by default (e.g. HSPA UTRAN) then it can re-register to the IMS indicating that audio can be supported and normal T-ADS procedures to be followed from there on.

To summarise the requirements derived from this alternative are:
The ICS UE registers with IMS and SCC AS for voice services using Gm as normal
The SCC AS uses initial T-ADS to signal the incoming voice calls using Gm
The ICS UE uses T-ADS to setup the voice call with CS media using MO CS fallback procedures
The ICS UE always uses Gm in order to signal the outgoing voice call and uses CS media established using MO CS fallback procedures

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing a system or method as claimed in any one of the claims of this specification and a machine-readable storage storing such a program. Still further, such programs may be conveyed electronically via any medium such as a communication signal carried over a wired or wireless connection and embodiments suitably encompass the same.

It will be also be appreciated that, throughout the description and claims of this specification, language in the general form of “X for Y” (where Y is some action, activity or step and X is some means for carrying out that action, activity or step) encompasses means X adapted or arranged specifically, but not exclusively, to do Y.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

In particular, documents referred to explicitly in the above description are as follows, and the contents of each of these documents are incorporated herein by reference:

[1] 3GPP TS 23.228, “IP Multimedia Subsystem (IMS); Stage 2”

[2] 3GPP TS 23.292, “IP Multimedia Subsystem (IMS) Centralized Services; Stage 2”

[3] 3GPP TS 23.272, “Circuit Switched (CS) fallback in Evolved Packet System (EPS); Stage 2”

[4] 3GPP TS 23.401, “General Packet Radio Service (GPRS) enhancements for Evolved Universal Terrestrial Radio Access Network (E-UTRAN) access”

[5] 3GPP TR 23.879, “Study on Circuit Switched (CS) domain services over evolved Packet Switched (PS) access”

[6] GB 6000410.5, Samsung GB patent application on advertising VoIP n Advantageously, the UE is thus able to adapt to, and take into account, the capabilities of the network and make a selection (decision) itself as to which voice communication mechanism to use in the current circumstances. This provides significant advantages over prior art techniques in which the network was adapted to accommodate a variety of UEs that might roam into its coverage area.

What is claimed is:

1. A voice call service communication system in a communication system, comprising:
a User Equipment (UE) configured to communicate with a communication network to determine if the communication network is capable of servicing a voice call in a Packet-Switched (PS) domain or not, and to service the voice call with the communication network in the PS domain if the communication network is capable of servicing the voice call in the PS domain.

2. The system as claimed in claim 1, wherein the PS domain is an Internet Protocol (IP Multimedia Subsystem (IMS) domain.

3. The system as claimed in claim 2, wherein the UE communicates with the communication network to determine if the communication network uses a Voice over IP (VoIP) of the IMS domain or not.

4. The system as claimed in claim 3, wherein the UE determines whether an operator policy of the communication network allows at least one alternative voice delivery mechanism or not, if the communication network does not use the VoIP of the IMS domain.

5. The system as claimed in claim 4, wherein the UE services the voice call with the communication network using the at least one alternative delivery mechanism if the operator policy of the communication network allows the at least one alternative voice delivery mechanism.

6. The system claimed in claim 1, wherein if the communication network is incapable of servicing the voice call in the PS domain, the UE communicates with the communication network to determine whether the communication network is capable of servicing the voice call in a Circuit-Switched (CS) domain or not.

7. The system as claimed in claim 6, wherein the UE services the voice call with the communication network in the CS domain if the communication network is capable of servicing the voice call in the CS domain.

8. The system as claimed in claim 7, wherein the PS domain is an Internet Protocol (IP) Multimedia Subsystem (IMS) domain.

9. A voice call service communication system in a communication system, comprising:
a communication network to communicate with a User Equipment (UE) and to service a voice call in a Packet-Switched (PS) domain or a Circuit-Switched (CS) domain.

10. The system as claimed in claim 9, wherein the PS domain is an Internet Protocol (IP) Multimedia Subsystem (IMS) domain.

11. The system as claimed in claim 10, wherein the communication network uses an operator policy allowing for at least one alternative voice delivery mechanism if the communication network does not use a Voice over IP (VoIP) of the IMS domain.

12. The system claimed in claim 11, wherein the communication network services the voice call with the UE using the at least one alternative delivery mechanism.

13. A method of servicing a voice call by a User Equipment (UE) in a communication system, comprising the steps of:
communicating with a communication network to determine if the communication network is capable of servicing the voice call in a Packet-Switched (PS) domain or not; and
servicing the voice call with the communication network in the PS domain if the communication network is capable of servicing the voice call in the PS domain.

14. The method as claimed in claim 13, wherein the PS domain is an Internet Protocol (IP) Multimedia Subsystem (IMS) domain.

15. The method as claimed in claim 14, further comprising the step of communicating with the communication network to determine if the communication network uses a Voice over IP (VoIP) of the IMS domain or not.

16. The method as claimed in claim 15, further comprising the step of determining whether an operator policy of the communication network allows at least one alternative voice delivery mechanism or not, if the communication network does not use the VoIP of the IMS domain.

17. The method as claimed in claim 16, further comprising the step of servicing the voice call with the communication network using the at least one alternative delivery mechanism if the operator policy of the communication network allows the at least one alternative voice delivery mechanism.

18. The method claimed in claim 13, further comprising the step of, if the communication network is incapable of servicing the voice call in the PS domain, communicating with the communication network to determine whether the communication network is capable of servicing the voice call in a CS Circuit-Switched (CS) domain or not.

19. The method as claimed in claim 18, further comprising the step of servicing the voice call with the communication network in the CS domain if the communication network is capable of servicing the voice call in the CS domain.

20. The method as claimed in claim 19, wherein the PS domain is an Internet Protocol (IP) Multimedia Subsystem (IMS) domain.
